(19) United States
(12) Patent Application Publication
(10) Pub. No.: US 2010/0090363 A1
(43) Pub. Date: Apr. 15, 2010

(54) METHOD AND APPARATUS FOR MANUFACTURING A MULTI-LAYERED WEB PRODUCT

(76) Inventor: Jes Kjaer Larsen, Beder (DK)

Correspondence Address: JAMES C. WRAY, 1493 CHAIN BRIDGE ROAD, SUITE 300, MCLEAN, VA, 22101, US

(21) Appl. No.: 12/312,051

(22) PCT Filed: Oct. 23, 2007
(86) PCT No.: PCT/DK2007/000452

§ 371 Date: Dec. 7, 2009

(30) Foreign Application Priority Data
Oct. 24, 2006 (DK) PA 2006 01387

(51) Int. Cl. B29C 47/02; B32B 27/12; B32B 27/32; B29C 47/06

(52) U.S. Cl. 264/171.23; 264/171.13; 425/83.1

(57) ABSTRACT

There is described a method and an apparatus for making a multilayered web product (1), including at least one fibre layer (6) which is formed by airforming combined with at least one additional layer in the form of a plastic film (13, 21). The fibre layer (6) is formed and fixed, preferably by heat fixing, and the plastic film (13, 21) is extruded directly upon or in immediate association to the previously formed and fixed fibre layer and is joined with the fibre layer by a compacting action in a compacting unit (9, 17). By the compacting, the hot plastic film will be joined to and pressed into the fibre layer for producing an integrated continuous product without need of separate heat supply.

### FIELD OF THE INVENTION

The present invention concerns a method for manufacturing a multilayered web product, including at least one fibre layer formed by airforming in combination with at least one additional layer in the form of a plastic film, at which the fibre layer is formed and fixed, preferably by a heat fixing, at which the plastic film is extruded directly upon or in immediate association to the previously formed and fixed fibre layer and at which the plastic film is joined with the fibre layer by compacting in a set of two compacting rollers.

The invention also concerns an apparatus for manufacturing a multilayered web product, including at least one fibre layer formed by airforming in combination with at least one additional layer in the form of a plastic film, and where an airforming unit includes a former wire: on, which the fibre layer is formed, the apparatus including fixing means, preferably for thermal fixing of the fibre layer, at least one extruder for extruding a plastic film directly upon or in immediate association to the fixed fibre web and a compacting unit comprising two squeezing rollers that squeeze the plastic film and the fibre web in a nip between the rollers.

### BACKGROUND OF THE INVENTION

It is prior art to make a multilayered web product that includes at least one fibre layer which is formed by airforming combined with at least one additional layer in the form of a plastic film. The fibre web is formed on a former wire or several succeeding former wires.

The manufacture may occur by using carding units or former heads. The plastic film is primarily selected as a transparent polyethylene film, and the combining of the two layers is performed in a calendar with heating to a temperature above the plasticizing temperature, so that the plastic film is joined to the fibre layer thereby. By the calendaring it becomes possible to provide compression and fixation of the fibres.

Such multilayered web products are used for making a plurality of end products where a core with absorbing properties and a liquid impermeable back side layer are desired. In such products there may also be a desire for a product with a perforated front side layer that allows liquid passage into the core, but where the exudation of liquid is prevented. Such products with double-sided, film-coated fibre layer are more difficult to make than the unilaterally film-coated products.

When making multi-layered web products of this type it is often desirable to use coloured plastic materials, but the known process is unsuited for this, as dye in the plastic material entails problems with cleaning the apparatuses used for the manufacture. In several products it is desirable to enable using coloured plastic material, e.g. in products for the meat pack market.

Furthermore, the process is disadvantageous in being based on the joining of previously formed films that are unrolled from rolled-up reels. This is a slow and expensive process as large amounts of energy are to be added for joining the layers in the multi-layered product.

A system mentioned by way of introduction is known from US2003/0148694. This document discloses that the film may be formed by extrusion directly on the fibre layer. However the process is slow as the fibre layer is a previously formed layer that is unrolled from rolled-up reels. Moreover there is no disclosure of the cooling of the multi-layered web product.

In short it may be said that the known systems for making multi-layer products, where different materials/technologies are used for the individual layers, are energy demanding and furthermore may imply reduced capacity of the manufacturing apparatuses.

### OBJECT OF THE INVENTION

It is the purpose of the invention to provide a method and an apparatus which enable making a multi-layered product by combining an airformed layer with one or more other plastic film layers, and which require limited energy and which may increase the capacity of the manufacturing apparatuses.

### DESCRIPTION OF THE INVENTION

According to the present invention, this is achieved by a method which is peculiar in that a least one of the rollers in said set of two compacting rollers having such temperature that cooling of the product is effected, and that the web product is formed by an inline process.

An apparatus according to the invention is peculiar in that at least one of said two rollers has such temperature that cooling of the product is effected and that the apparatus is formed for performing an inline process.

With a method and an apparatus according to the invention, it is possible to achieve high production speeds when making multi-layered web products.

It is important that the web product is formed by an inline process. There is thus established a rapid and efficient process without any need for rolling up, and where at the same time it is possible to utilise the heat in the extruded plastic for establishing attachment between the fibre layer and the film.

By the present invention it thus becomes possible to produce an airformed fibre layer on a separate and suitable former wire and to conduct this fibre layer to an extruder which extrudes the plastic film directly on the fibre layer. By the compacting, the hot plastic film will he joined with and pressed into the fibre layer for producing an integrated continuous product without any need of separate heat supply.

By the compacting rollers are used which have such a temperature that cooling of the product is effected. Hereby it becomes possible to perform a rolling up directly after the compacting unit.

The attachment between fibre layer and film is established in a secure way due to uneven surface in the fibre layer. This entails that the plasticized and entirely or partially fluid plastid from the extruder is pressed down into the irregularities in the surface of the fibre layer.

According to yet an embodiment, the method is peculiar in that the extrusion is performed by a film being extruded out on the surface of a roller forming part of the compacting unit. This roller will have a temperature which is lower than the temperature of the plastic, so that cooling of the plastic layer occurs. The roller temperature will preferably be between 50 and 75° C. in order to provide cooling of the plastic film which can have extrusion temperatures between 180 and 250° C.

According to a further embodiment, the method is peculiar in that the compacting of the plastic film and the fibre layer is performed between compacting rollers that exert a pressure between 1 and 60 N/mm. This provides sufficient force so as to ensure efficient attachment between the fibre layer and the film.

An apparatus according to the invention will thus be peculiar in that the compacting unit includes two squeezing rollers that squeeze the web product in a nip between the rollers. One of these squeeze rollers may be the roller upon which the film is extruded in order to be provided in immediate association to the fibre layer.

According to a further embodiment, the method is peculiar in that the plastic film is a coloured plastic film, enabling satisfaction of a long-time user wish and at the same time providing possibility of an efficient and energy saving production.

According to yet an embodiment, the method is peculiar in that a plastic film is extruded on each side of the airformed fibre layer. It is thus possible in an inline process to extrude a film layer on both sides of the fibre layer in one and the same procedure. If desired, various materials can be used, e.g. PE at one side and PP at the other side.

An apparatus according to the invention will thus be designed with an extruder at each side of the fibre web for extruding a plastic film on both sides of the fibre web.

Furthermore, it is possible that one side can be perforated in order to create liquid permeability, but simultaneously the ability of retaining liquid before performing extrusion of a plastic layer on the other side for establishing a liquid impervious layer.

According to a further embodiment, the method is peculiar in that at least the airformed fibre layer is made up of cellulose fibres containing latex and/or secondary component fibres for fixing the fibre layer. The fibre layer may thus be bonded by latex bonding or by bonding with secondary component fibres, or a combination thereof, depending on whether the fibre layer can be passed through an oven for activating fibres/latex.

Moreover, the fibre layer can be made with SAP or SAF, if this is desired with regard to desired properties in the end product.

According to yet an embodiment, the method is peculiar in that the plastic film is made of PP, PE, PES, PLA or corresponding plastic materials. By direct extrusion there is thus no limitation to the plastic materials that may be applied.

### DESCRIPTION OF THE DRAWING

The invention will now be explained more closely in the following with reference to the accompanying schematic drawing, where:

FIG. 1 shows schematic draft of a first embodiment of an apparatus according to the invention for use in making a multilayered web product with film applied on one side of a fibre layer; and

FIG. 2 shows schematic draft of a second embodiment of an apparatus according to the invention for use in making a multilayered web product with film applied on both sides of a fibre layer.

### DETAILED DESCRIPTION OF THE INVENTION

In the following, identical or corresponding elements repeated in different Figures will be denoted with the same reference number. Thus explanation for each single constructional feature will not be provided in connection with each of the Figures.

Instead, an explanation will be given to the points whereby the different embodiments for the apparatus according to the invention are differing from each other.

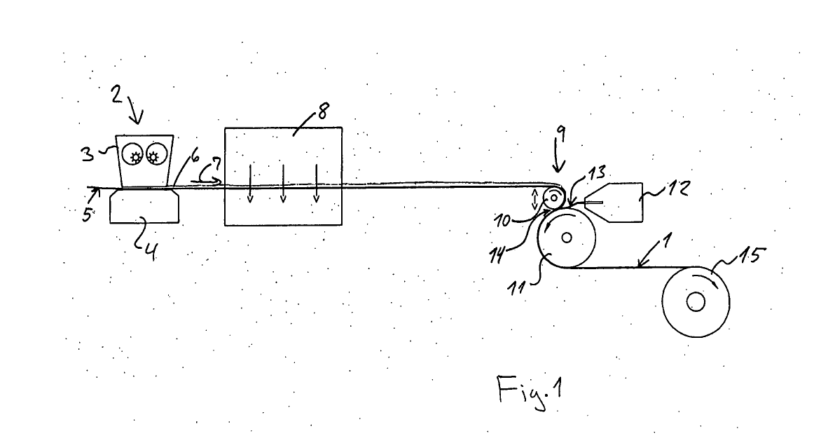

FIG. 1 shows an apparatus for forming a multilayered web product 1. The apparatus comprises an airforming unit 2 having a former head 3 which is disposed opposite a suction box 4 with a former wire 5 moving there between and upon which a fibre layer 6 is formed. The fibre layer 6 may contain latex or secondary component fibres. An arrow 7 indicates the direction of movement of the former wire 5.

Then a heating oven 8 is provided for heating and fixing the fibre layer. The former wire acts as transport wire for conveying the fibre layer through the heating oven and the subsequent part of the process. Alternatively, the fibre web can be transferred to a conveyor wire.

After the heating oven 8 there is a compacting unit 9 having a first roller 10 and a second roller 11. An extruder 12 is provided for extruding a plastic film 13 out on the second roller 11, which may be termed a cooling roller, as it typically has a temperature between 50 and 75° C. for providing cooling of the plastic film that may have extruding temperatures between 180 and 250° C.

Between the two rollers 10, 11, a nip 14 is formed for compacting the plastic film 13 and the fibre layer 6 at a pressure between 1 and 60 N/mm.

A rolling-up unit 15 is disposed after the second roller 11 for rolling up the multilayered product 1 with regard to subsequent handling. Alternatively, the multilayered product 1 may be conveyed directly to a processing unit.

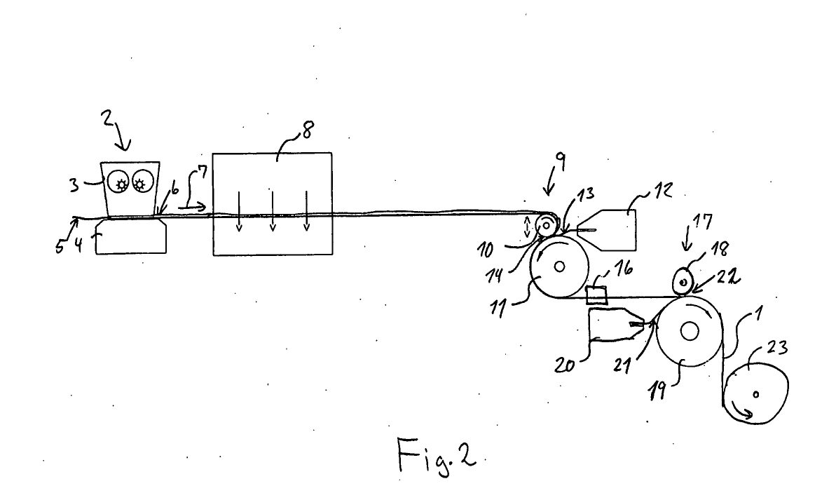

In FIG. 2 appears an apparatus corresponding to the one shown in FIG. 1, but where after the second roller 11 of the compacting unit 9 there is provided a perforating unit 16 that may perform perforation of the formed plastic film 13. Then is provided a second compacting unit 17 having a first roller 18 and a second roller 19.

A second extruder 20 is provided for extruding a second plastic film 21 out on the second roller 19, which also can be called a cooling roller, as it typically has a temperature between 50 and 75° C. for providing cooling of the plastic film 21 that may have extruding temperatures between 180 and 250° C. As it appears, the second plastic film 21 will be disposed at the opposite side of the fibre layer 6 relative to the plastic film 13.

Between the two rollers 18, 19, a nip 22 is formed for compacting the plastic films 13, 21 and the fibre layer 6 at a pressure between 1 and 60 N/mm.

A rolling-up unit 23 is disposed after the second roller 19 for rolling up the multilayered product 1 with regard to subsequent handling. Alternatively, the multilayered product 1 may be conveyed directly to a processing unit.

The products that may be formed may e.g. be intended for the meat pack market and consist of two layers with film at one side and a fibre layer formed of airformed absorbing fibres. This airformed fibre layer may include bicomponent fibres, monocomponent fibres, cellulose fibres or possible combinations thereof.

It is also possible to make a product where there are two film layers, and where one layer is a film that may act as a front side layer, where the other film layer is a back side layer, while the intermediate layer could be an absorbing core. It will thus be possible to form a multi-layer fabric which then can be punched, e.g. for forming incontinence products or other absorbing products that are provided with an external layer of films and a centre core which is absorbing.

Even if not shown above, the apparatus and the plant of which it forms a part will be provided with monitoring means that may monitor operational conditions and use the results of such monitoring for automatic control of e.g. the layer forming units. Such control and monitoring systems will, however, be possible to design for the skilled in the art in light of the present description of the invention.

1. A method for manufacturing a multilayered web product, including at least one fibre layer formed by airforming in combination with at least one additional layer in the form of a plastic film, at which the fibre layer is formed and fixed, preferably by a heat fixing, at which the plastic film is extruded directly upon or in immediate association to the previously formed and fixed fibre layer, and at which the plastic film is joined with the fibre layer by compacting in a set of two compacting rollers, wherein a least one of the rollers in said set of two compacting rollers having such temperature that cooling of the product is effected, and that the web product is formed by an inline process.

2. Method according to claim 1, wherein the plastic film may be a coloured plastic film.

3. Method according to claim 1, wherein a plastic film is extruded on each side of the airformed fibre layer.

4. Method according to claim 1, wherein at least the airformed fibre layer is made up of cellulose fibres containing latex and/or secondary component fibres for fixing the fibre layer.

5. Method according to claim 1, wherein the plastic film is made of PP, PE, PES, PLA, or a combination thereof, or of corresponding plastic materials.

6. Method according to claim 1, wherein the compacting of the plastic film and the fibre layer is performed between compacting rollers that exert a pressure between 1 and 60 N/mm.

7. Method according to claim 1, wherein said at least one roller has a temperature between 50 and 75° C.

8. An apparatus for manufacturing a multilayered web product, including at least one fibre layer formed by airforming in combination with at least one additional layer in the form of a plastic film, and where an airforming unit includes a former wire on which the fibre layer is formed, the apparatus including fixing means, preferably for thermal fixing of the fibre layer, at least one extruder for extruding a plastic film directly upon or in immediate association to the fixed fibre web, and a compacting unit comprising two squeezing rollers that squeeze the plastic film and the fibre web in a nip between the rollers, wherein at least one of said two rollers has such temperature that cooling of the product is effected and that the apparatus is formed for performing an inline process.

9. Apparatus according to claim 8, wherein an extruder is provided at each side of the fibre web for extruding a plastic film on both sides of the fibre web.

10. Apparatus according to claim 8, wherein the said at least one roller has a temperature between 50 and 75° C.
